(19) United States
(12) Patent Application Publication
(10) Pub. No.: US 2015/0261542 A1
(43) Pub. Date: Sep. 17, 2015

(54) DATA PROCESSING APPARATUS AND METHOD FOR PERFORMING DATA PROCESSING OPERATION WITH A CONDITIONAL PROCESSING STEP

(71) Applicant: ARM LIMITED, Cambridge (GB)

(72) Inventor: Ian Michael CAULFIELD, Cambridge (GB)

(73) Assignee: ARM LIMITED, Cambridge (GB)

(21) Appl. No.: 14/210,621

(22) Filed: Mar. 14, 2014

(51) Int. Cl. G06F 9/38

(52) U.S. Cl. CPC G06F 9/3867

(57) ABSTRACT

A data processing apparatus has a pipeline for performing a processing operation involving a conditional step which is required only if at least one input operand satisfies a predetermined condition. Control circuitry detects whether the condition is satisfied. If not, then the pipeline is controlled to perform the operation bypassing the conditional step to generate the output operand a first number of cycles later than a start cycle in which the operation starts, and the output operand is forwarded over a forwarding path. If the condition is satisfied, then the pipeline performs the operation including the conditional step to generate the output operand a second number of cycles later than the start cycle, where the second number is greater than the first number. The output operand is written to a destination register the same number of cycles later than the start cycle regardless of whether the condition is satisfied.

### BACKGROUND

1. Technical Field

The present technique relates to the field of data processing. More particularly, the technique relates to a data processing apparatus and method for performing a data processing operation which has a conditional processing step.

2. Description of the Prior Art

A data processing apparatus may have a processing pipeline which has a number of pipeline stages arranged to perform a data processing operation. Some data processing operations have at least one conditional processing step which is only required some of the time, depending on the data being processed. The present technique seeks to provide a more efficient pipeline arrangement for handling such processing operations.

### SUMMARY OF THE PRESENT TECHNIQUE

Viewed from one aspect, the present technique provides a data processing apparatus comprising:

a plurality of registers configured to store operands for processing;

a processing pipeline configured to perform a data processing operation for generating an output operand in response to at least one input operand and for writing the output operand to a destination register of said plurality of registers, the data processing operation including at least one conditional processing step which is required only if the at least one input operand satisfies a predetermined condition;

a forwarding path configured to forward the output operand for use by a subsequent data processing operation; and

control circuitry configured to detect whether the at least one input operand for the data processing operation satisfies the predetermined condition, and:

(a) if the at least one input operand does not satisfy the predetermined condition, to control the processing pipeline to perform the data processing operation bypassing the at least one conditional processing step to generate the output operand a first number of processing cycles later than a start processing cycle in which the processing pipeline starts performing the data processing operation, and to forward the output operand via the forwarding path before the output operand has been written to the destination register; and
(b) if the at least one input operand satisfies the predetermined condition, to control the processing pipeline to perform the data processing operation including the at least one conditional processing step to generate the output operand a second number of processing cycles later than the start processing cycle, where the second number is greater than the first number;

wherein the processing pipeline is configured to write the output operand to the destination register a predetermined number of processing cycles later than the start processing cycle, said predetermined number being the same regardless of whether the at least one input operand satisfies the predetermined condition.

A data processing operation for generating an output operand in response to an input operand and for writing the output operand to a destination register may have at least one conditional processing step which is required only if the at least one input operand satisfies a predetermined condition. The present technique recognises that the way in which this conditional processing step is handled can greatly affect performance of the processing pipeline, especially if the at least one conditional processing step is only required relatively rarely. One approach may be to provide one or more pipeline stages for performing the at least one conditional processing step and to route an instruction for performing the data processing operation through that pipeline stage irrespective of whether or not the conditional processing step(s) is actually required. However, in this case a small minority of operations requiring the conditional processing step may delay the processing of all instructions, which is undesirable. Another approach may be to statically determine whether or not the conditional processing step will be required for a given program to be executed, and if none of the operations to be performed require the conditional processing step(s) then the circuitry within the pipeline for performing these steps can be bypassed. However, with this approach even if there is only one operation that requires the conditional processing step, the conditional processing would have to be enabled and again all operations may be delayed by being passed through additional stages.

The present technique recognises that a more efficient approach is to determine, based on the at least one input operand for the data processing operation, whether a predetermined condition is satisfied, indicating that the at least one conditional step is required. If the at least one input operand does not satisfy the predetermined condition then the processing pipeline can perform data processing operation bypassing the at least one conditional processing step, so that the output operand is generated a first number of processing cycles later than the start processing cycle for the data processing operation. On the other hand, if the condition is satisfied then the operation is performed including the conditional step, to generate the output operands a second number of processing cycles later than the start cycle, with the second number being larger than the first number. Hence, operations which do not require the conditional processing step can bypass this step to generate the output value earlier.

However, the output operand may need to be written to a destination register, and even if the output operand is generated in an earlier cycle by bypassing the conditional step, it may not be possible to perform the register writes earlier. For example, there may be relatively few register write ports, and so there may be some competition for register write ports. It may not be known until relatively late in the pipeline whether or not the at least one input operand satisfies the predetermined condition and so at this point it may be difficult bring forward the register write since other instructions may already have taken all the available write ports in the earlier cycle. Nevertheless, it is desirable to make the output operand generated in the case where the conditional step is bypassed available to other data processing operations earlier than would be the case if the conditional step is required.

To address this problem, the present technique provides a forwarding path for forwarding the output operand for use by subsequent data processing operation. If the conditional step is bypassed, then the output operand generated the first number of processing cycles after the start processing cycle is forwarded via the forwarding path before the output operand is written to the destination register. The processing pipeline can then wait until the cycle in which the output operand would normally be written to the destination register if the conditional processing step was required before writing the output operand to the destination register. That is, the write to the destination register occurs the same number of cycles after the start processing cycle regardless of whether the conditional processing step is performed or not. This simplifies the control of the register write since the timing of the register write is now predictable and does not need to change part-way down the pipeline. Meanwhile the forwarding path allows a performance improvement by allowing subsequent operations to use the generated output operand before it has been written into the register.

The processing pipeline may have a bypass processing path and a second processing path. The second processing path may have circuitry for performing the at least one conditional processing step, while the bypass processing path may not have such circuitry. This allows the control circuitry to select an appropriate one of these paths depending on whether the input operand satisfies the predetermined condition. The forwarding path may be coupled to the bypass processing path and the number of pipeline stages between the start of the bypass processing path and the point at which the early forwarding path receives the output operand may be smaller than the number of stages between the start of the second processing path and the point at which the register write occurs.

The control circuitry can control which of the bypass path and the second processing path is used in different ways. In some cases, the control circuitry may control one of the bypass processing path and the second processing path to be inactive so that it does not generate a output value and the output operand is generated only using the other path. However, it may be simpler to simply allow both paths to generate an output value and then select the appropriate output depending on whether the at least one input operand satisfied the predetermined condition.

It is possible for the processing pipeline to have entirely separate processing paths for performing the data processing operation, with one path being used for the bypass case and the other path being used for the case where the conditional processing step is required. However, typically there will be some steps which are common to both cases and so it can be more efficient to provide a shared processing path which performs at least one initial processing step required by the data processing operation regardless of whether the at least one input operand satisfies the predetermined condition. Once the processing with the shared processing path is complete then one of the bypass path and second path may be selected as discussed above.

To allow the write to the destination register to occur at the same timing relative to the start processing cycle regardless of whether the input operand satisfies the predetermined condition, the bypass processing path may have at least one no-operation (no-op) pipeline stage which receives an output value from a preceding pipeline stage and outputs the received output value unchanged. The no-op pipeline stage may buffer the output value for at least one cycle to delay the output value until it is written to the destination register.

In some cases, the at least one conditional step may be the last step(s) to be performed in the data processing operation, with no other steps occurring afterwards. In this case, the bypass path may include one or more no-op pipeline stages as described above and need not include any other circuitry for performing processing steps.

In other cases, there may be at least one further processing step to be performed after the at least one conditional step and which is required regardless of whether the at least one input operand satisfies the predetermined condition. In this case, then it can be useful to duplicate the circuitry for performing the at least one further processing step so that one version is provided on the bypass path and another version is provided on the second processing path which concludes the conditional step. The bypass processing path may be arranged so that its circuitry will start performing the at least one further processing step a smaller number of processing cycles after the start processing cycle than the corresponding circuitry in the second processing path. In this way, the bypass processing path can generate the output operand in an earlier cycle than would be the case if the second processing path was used, to improve performance in the case when the predetermined condition is not satisfied.

The present technique can be used with any data processing operation which involves at least one conditional step which is only required if the at least one input operand satisfied a predetermined condition. The predetermined condition may be a condition met by the one or more input operands themselves, or could be a condition that is satisfied if the input operands are such that an intermediate value produced by the processing pipeline will have a certain property. To determine whether the predetermined condition is satisfied, the control circuitry may use an intermediate value produced by the processing pipeline, or in other cases the control circuitry may decide whether the condition is satisfied independently of the processing carried out by the processing pipeline.

The present technique is particularly useful where a data processing operation is a floating point data processing operation where the at least one input operand and output operand are floating point operands which each have a significand representing the significant bits of the operand and an exponent representing the position of a radix point in the significand. When numbers are represented in floating point form (such as using the IEEE floating point standard, e.g. IEEE-754), there are sometimes some special cases which require processing which is not required for the majority of floating point operations using normal floating point values. For example, the special cases may include processing of not a number (NaN) floating point values (such as infinity, square roots of negative numbers, or the result of 0 divided by 0, for example). For most operations, steps for handling these numbers will not be required but occasionally there is a need to perform a conditional step to handle these special cases. The present technique can make handling of these cases more efficiently to speed up the cases when the conditional step is not required.

More particularly, the present technique is useful when the at least one conditional step comprises one or more steps for handling a denormal floating point value. A denormal floating point value represents a number whose magnitude is greater than zero, but smaller than the smallest possible magnitude representable using a normal floating point value. While a normal floating point value has a bit value of 1 as its most significant bit (1.????? . . . times a power of two indicated by the exponent), a denormal floating point value has a bit 0 as its most significant bit (0.????? . . . times a power of two indicated by the exponent), allowing smaller numbers to be represented using an exponent comprising a limited number of bits. The processing for handling a denormal floating point value can be relatively complex, and so may require at least one additional stage in the processing pipeline. However, in practice denormal values do not occur very often and so incurring the penalty of the delay through this additional stage for all operations may be detrimental to performance. By implementing the present technique to allow the steps for handling denormal values to be omitted when possible, performance can be improved, while still managing the write to the destination register in an efficient way.

More particularly, the conditional step may include one or more steps for normalising the denormal floating point value to generate a normal floating point value, or for denormalising a normal floating point value to generate a denormal floating point value. Normalising and denormalising can be performed by shifting the significand of the floating point value and adjusting the exponent. The normalising may be required if a floating point operation produces a denormal floating point value. The IEEE-754 standard for floating point arithmetic requires that some operations generate a normal floating point value as their output operand, and so if the intermediate result of these operations is denormal than it has to be normalised. On the other hand, there may be some operations that produce a value which cannot be represented as a normal value, and so the value may need to be denormalised to allow a smaller number to be represented. In both cases, the normalising or denormalising steps may be required only for some operations, and can often be bypassed to generate the output operand earlier.

In general the denormal handling steps may be performed if the at least one input operand is such that an operand processed somewhere by the processing pipeline has a denormal floating point value. This may be the case if one of the input operands is itself denormal, and may occur even if all the input operands are normal but an intermediate operand somewhere in the pipeline becomes denormal. The control circuitry can detect both these cases and control the processing pipeline to perform the optional denormal handling steps if either of these events occurs.

More particularly, the data processing operation may be a floating point multiply operation for multiplying two input operands to generate the output operand. With a multiply operation, the product of the two input operands may be denormal if either of the input operands is itself denormal, or if a product of the two input operands becomes denormal because both the input operands were relatively small. Hence, the control circuitry may determine that the predetermined condition is satisfied if any of the following conditions applies:

(a) at least one of the two input operands has a denormal floating point value;
(b) a product of the two input operands would have a denormal floating point value; and
(c) the sum of the exponents of the two input operands is less than a predetermined threshold.

Condition (c) above is an example of determining whether condition (b) is satisfied. It may be difficult to determine quickly whether the product of the two input operands would definitely have a denormal floating point value, since this may depend on the multiplication result of the significands of the two input operands, which would take some time to be available. A simpler way of estimating whether there the product may be denormal can be to use condition (c) and to simply add the exponents of the input operands. If the sum of the exponents is less than a threshold than this can indicate that there is a possibility that the product could be denormal, whereas if the sum is greater than the denormal threshold then it can be known that the product will definitely not be denormal. A given apparatus may use any one or more of these conditions (a)-(c) to determine whether the predetermined condition is satisfied.

The data processing apparatus may have the ability to disable handling of denormal floating point values. A control signal may be received and this may indicate whether denormal handling is enabled or disabled. If the control signal indicates that handling a denormal floating point values is disabled, then any denormal values may be replaced with zero and the processing pipeline may be controlled to use the bypass path for all data processing operations. On the other hand, when the control signal indicates that handling a denormal values is enabled, then the processing may be as discussed above where the control circuitry controls whether the conditional step is performed based on whether the predetermined condition is satisfied. Irrespective of whether the control signal indicates that denormal handling is enabled or disabled, the writing of the output operand to the destination register may still occur the same predetermined number of cycles later than the start processing cycle, so as to provide a predictable timing for the register write, but the forwarding path may output the output operand for use by subsequent instructions earlier than the operand would be available in the destination register.

The processing pipeline may perform the data processing operation in response to an instruction which is issued to the pipeline by the issue circuitry. In the case of a floating point multiply operation, the pipeline may perform the operation in response to a floating point multiply instruction issued into the pipeline. The pipeline may also perform the same multiply operation in response to a floating point multiply-add instruction issued by the issue circuitry, for which the output operand produced by the multiply pipeline is then added to another input operand to produce a result value.

Viewed from another aspect, the present technique provides a data processing apparatus comprising:

a plurality of register means for storing operands for processing;

processing pipeline means for performing a data processing operation for generating an output operand in response to at least one input operand and for writing the output operand to a destination register means of said plurality of register means, the data processing operation including at least one conditional processing step which is required only if the at least one input operand satisfies a predetermined condition;

forwarding means for forwarding the output operand for use by a subsequent data processing operation; and

control means for detecting whether the at least one input operand for the data processing operation satisfies the predetermined condition, and:

(a) if the at least one input operand does not satisfy the predetermined condition, controlling the processing pipeline means to perform the data processing operation bypassing the at least one conditional processing step to generate the output operand a first number of processing cycles later than a start processing cycle in which the processing pipeline means starts performing the data processing operation, and to forward the output operand via the forwarding means before the output operand has been written to the destination register means; and
(b) if the at least one input operand satisfies the predetermined condition, controlling the processing pipeline means to perform the data processing operation including the at least one conditional processing step to generate the output operand a second number of processing cycles later than the start processing cycle, where the second number is greater than the first number;

wherein the processing pipeline means is configured to write the output operand to the destination register means a predetermined number of processing cycles later than the start processing cycle, said predetermined number being the same regardless of whether the at least one input operand satisfies the predetermined condition.

Viewed from a further aspect, the present technique provides a method of performing a data processing operation for generating an output operand in response to at least one input operand and for writing the output operand to a destination register of a plurality of registers, the data processing operation including at least one conditional processing step which is required only if the at least one input operand satisfies a predetermined condition; the method comprising:

detecting whether the at least one input operand for the data processing operation satisfies the predetermined condition;

if the at least one input operand does not satisfy the predetermined condition, controlling a processing pipeline to perform the data processing operation bypassing the at least one conditional processing step to generate the output operand a first number of processing cycles later than a start processing cycle in which the processing pipeline starts performing the data processing operation, and forwarding the output operand via a forwarding path before the output operand has been written to the destination register, for use by a subsequent data processing operation;

if the at least one input operand satisfies the predetermined condition, controlling the processing pipeline to perform the data processing operation including the at least one conditional processing step to generate the output operand a second number of processing cycles later than the start processing cycle, where the second number is greater than the first number; and

writing the output operand to the destination register a predetermined number of processing cycles later than the start processing cycle, said predetermined number being the same regardless of whether the at least one input operand satisfies the predetermined condition.

Further aspects, features and advantages of the present technique will be apparent following detailed description which is to be read in conjunction with the accompanying drawings.

### BRIEF DESCRIPTION OF THE DRAWINGS

FIG. 1 schematically illustrates single and double precision floating point representation of numbers;

FIG. 2 provides a comparative example for explaining a floating point multiply operation;

FIG. 3 shows a second comparative example showing an extension of the floating point multiply operation to handle denormal floating point numbers;

FIG. 4 shows a first example of a data processing apparatus according to the present technique in which a conditional step of a data processing operation can be bypassed;

FIG. 5 schematically illustrates a second example apparatus according to the present technique;

FIG. 6 illustrates a method of performing a data processing operation including a conditional step; and

FIG. 7 shows a method in which a conditional part of the data processing operation can be disabled using a control flag.

### DESCRIPTION OF EXAMPLE EMBODIMENTS

In floating point representation, numbers are represented using a significand 1.F or 0.F, an exponent E and a sign bit S. The sign bit represents whether the floating point number is positive or negative, the significand represents the significant digits of the floating point number, and the exponent represents the position of the radix point (also known as a binary point) relative to the significand. By varying the value of the exponent, the radix point can “float” left and right within the significand. This means that for a predetermined number of bits, a floating point representation can represent a wider range of numbers than a fixed point representation (in which the radix point has a fixed location within the significand). However, the extra range is achieved at the expense of reduced precision since some of the bits are used to store the exponent. Sometimes, a floating point arithmetic operation generates a result with more significant bits than the number of bits used for the significand. If this happens then the result is rounded to a value that can be represented using the available number of significant bits.

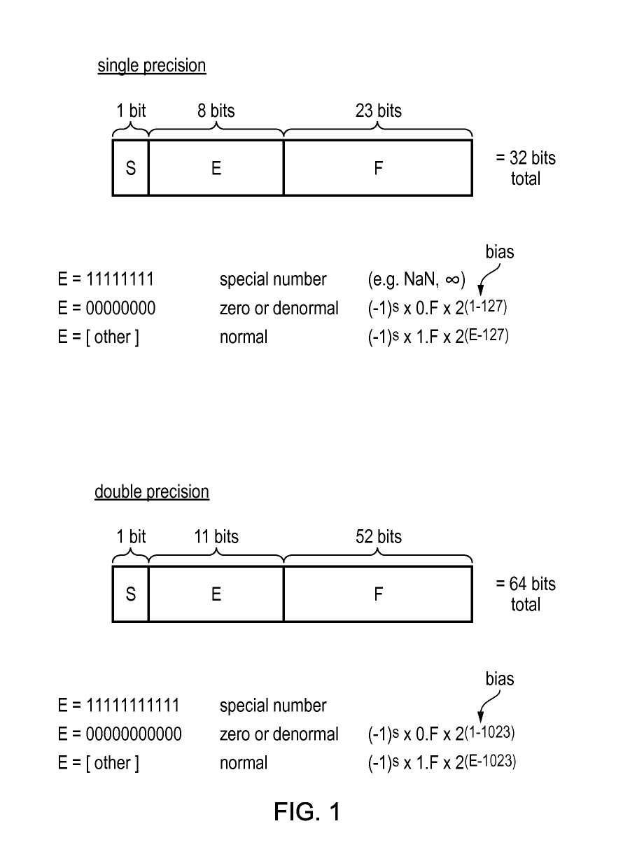

FIG. 1 of the accompanying drawings shows how floating point numbers are stored within a register or memory. In a single precision representation, 32 bits are used to store the floating point number. One bit is used as the sign bit S, eight bits are used to store the exponent E, and 23 bits are used to store the fractional portion F of the significand. For normal values, the 23 bits of the fractional portion F, together with an implied bit having a value of one, make up a 24-bit significand 1.F. The radix point is initially assumed to be placed between the implied bit and the 23 stored bits of the significand. The stored exponent E is biased by a fixed value 127 such that in the represented floating point number the significand is shifted right from its initial position relative to the radix point by E-127 places if E-127 is negative (e.g. if E-127=−2 then a significand of 1.01 represents 0.0101), or left from its initial position by E-127 places if E-127 is positive (e.g. if E-127=2 then a significand of 1.01 represents 101). The bias is used to make it simpler to compare exponents of two floating point values as then both negative and positive shifts of the radix point can be represented by a positive value of the stored exponent E. As shown in FIG. 1, the stored representation S[31], E[30:23], F[22:0] represents a number with the value (−1)^{S}*1.F*2^{(E-}127). A single-precision floating point number in this form is considered to be “normal”. If a calculated floating point value is not normal (for example, it has been generated with the radix point at a position other than between the left-most two bits of the significand), then it is normalized by shifting the significand left or right and adjusting the exponent accordingly until the number is of the form (−1)^{S}*1.F*2^{E-127}.

A double precision format is also provided in which the significand and exponent are represented using 64 stored bits. The 64 stored bits include one sign bit, an 11-bit exponent and the 52-bit fractional portion F of a 53-bit significand 1.F. In double precision format the exponent E is biased by a value of 1023. Thus, in the double precision format a stored representation S[63], E[62:52], F[51:0] represents a floating point value (−1)^{S}*1.F*2^{E-1023}. It will be appreciated that the present technique could be applied to the single precision format, the double precision format or any other floating point format which uses different number of bits or different bias values for the floating point representation.

As well as normal floating point values, the floating point representation can also represent other quantities. If the exponent E for a value has all its bits set to 1 then this represents a special number, such as infinity and “not a number” (NaN) values, which are results which cannot be represented using a real number such as the square root of a negative number, the division 0/0, the result of a calculation using infinity and the result of a function applied to a value outside its defined range (e.g. the inverse sine or cosine of number less than −1 or greater than +1). When the exponent has all its bits equal to 1, infinity is typically represented by the significand bits F all being equal to 0, while other NaN values are represented by non-zero values for the significand. Techniques for handling infinity and NaN values are well known and any prior art technique can be used. Therefore the handling of these numbers will not be discussed in detail herein.

When the exponent E has its bits all equal to zero then this represents either zero or a denormal number. The floating point value is equal to zero if its significand bits F are all zero. If any bit of the significand is equal to 1 then the number is a denormal number. A denormal number has its implicit bit of the significand equal to zero instead of one as in the case of normal numbers. This allows values smaller than the smallest number represented using a normal number. For example, in the single precision case the smallest value representable using a normal number is 1.0*2⁻¹²⁶, while if a denormal number is used than the smallest represent value is 2⁻¹⁴⁹ (0.00000000000000000000001*2⁻¹²⁶), since the leading one can now be in the least significant bit of the 23-bit significand field F.

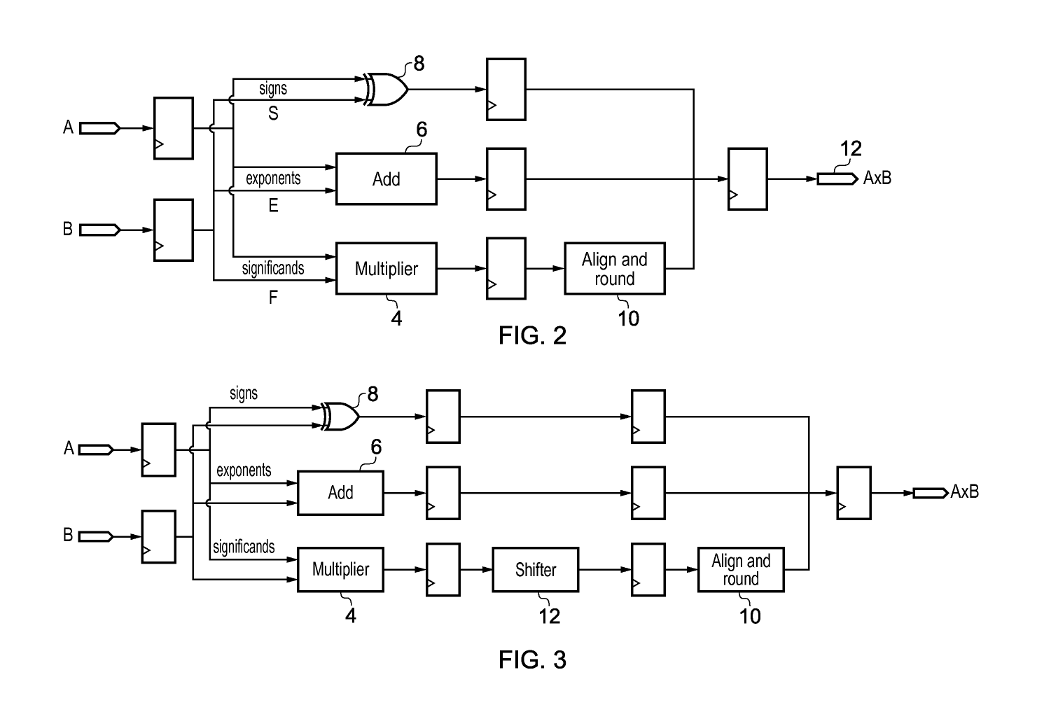

FIG. 2 explains the basic principle of a floating point multiply pipeline, assuming that all floating point values processed are normal. Two input operands A, B are supplied to the pipeline. The significands F of the two input operands are multiplied by a multiplier 4. The unbiased exponents E of the input operands are added together by adder 6. If the input exponents E are the unbiased exponents (the bias has already been subtracted), then these exponents E can simply be added together, while if the input exponents are the biased exponents as represented in a stored floating point value, then the bias is also subtracted by adder 6 to get the correct result. The sign bits S of the two input operands are XORed (exclusive OR) by XOR gate 8. The product produced by the multiplier 4 has more bits than are available in the floating point representation (for example, multiplying two 52 bit values results in a 104 bit value), so some bits are to be truncated. Therefore, an alignment and rounding circuit 10 is provided in a second pipeline stage for aligning (shifting) the product produced by the multiplier 4 so that the radix point is to the right of the leading ‘1’ bit of the significand, and rounding the product to the nearest value representable using the floating point representation being used. The rounding may comprise selectively adding 1 to the aligned product depending on whether the product value is closer to the nearest representable value above the product value or the nearest representable value below the product value. In the case where the product value is exactly halfway between the two nearest values representable using the floating point format, then different rules may be used to resolve the tie, such as round away from zero, round towards zero, round towards positive infinity, round towards negative infinity, round to the nearest even value, round to the nearest odd value, or round randomly up or down. The aligned and rounded product produced by circuit 10 is combined with the exponent produced by the adder 6 and the sign bits produced by the XOR gate 8 to generate a normal floating point value as the output operand, which is then output from write port 12 to a destination register.

However, to implement a floating point multiply pipeline which complies with the IEEE standard there are a few additional complications. As discussed above, there are special numbers such as infinity and NaN values which require special processing. These can generally be handled alongside the main calculation, and any prior art technique may used for handling these values.

However, denormal numbers as discussed above may require more complex processing. If either of the input operands A, B is a denormal floating point number, or if both inputs are normal but are small enough that the product would be denormal, then the IEEE standard requires that the result is normalised. Therefore, to support denormal numbers, a shifter 12 may be provided as shown in FIG. 3 which provides a renormalisation or denormalisation shift after the multiplication but before the rounding at the pipeline stage 10. With double precision floating point values, the product produced by the multiplier 4 may have 104 bits and so shifting this number of bits can take some time and so generally an extra pipeline stage may be required to handle the normalisation. This would greatly slow down the processing of all floating point multiplications if every instruction has to go through the shift stage.

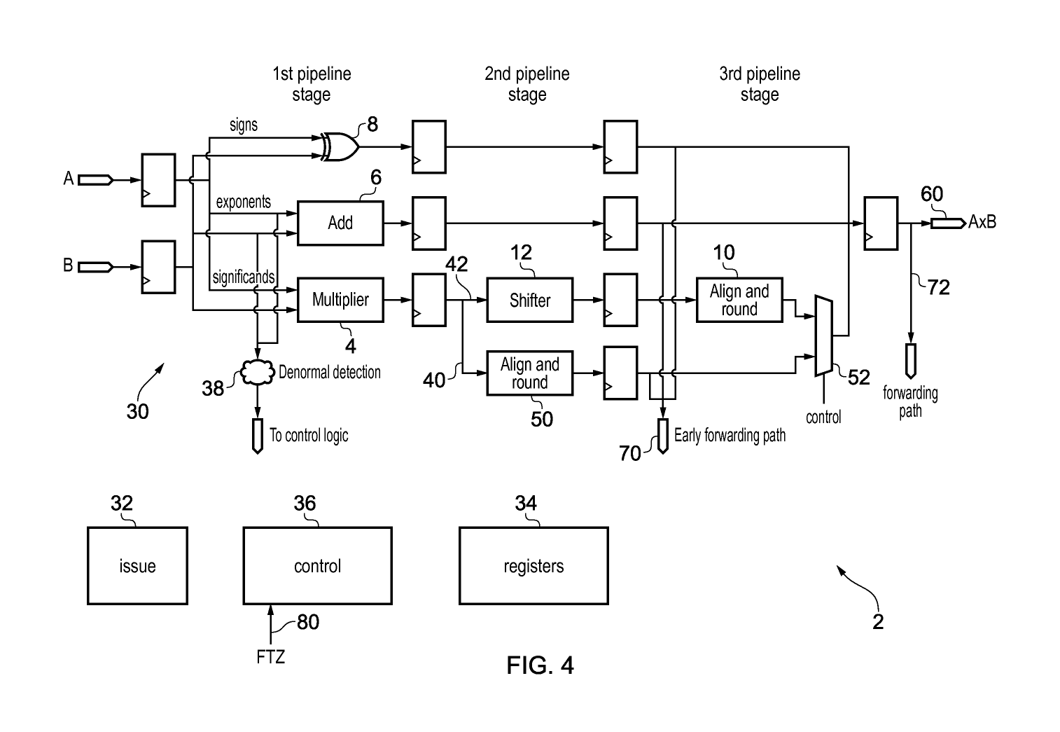

FIG. 4 shows a data processing apparatus 2 according to the present technique for addressing this problem. The apparatus 2 has a processing pipeline 30 for handling floating point multiplications, which may be performed in response to stand-alone floating point multiply instructions or combined multiply-add instructions. In the case of a multiply-add instruction, the multiply result produced by the pipeline 30 would be forwarded to an add pipeline to add the multiply result produced by multiplying two operands to a third operand. The apparatus 2 also has issue control circuitry 32 for issuing the instructions to the pipeline 30 to control the pipeline 30 to perform a multiply operation, registers 34 for storing input operands to be processed by the pipeline 30 and output operands generated by the pipeline 30, and control circuitry 36 for controlling the operation of the pipeline.

As in FIG. 3, the pipeline 30 has a first pipeline stage with a multiplier 4, adder 6, and XOR gate 8 which function in the same way as in FIGS. 2 and 3, a second pipeline stage with a shifter 12 for normalising any denormal value produced by the first pipeline stage, and a third pipeline stage including the alignment and rounding circuitry 10. However, in FIG. 4 a bypass path 40 is provided through the second and third pipeline stages in addition to a second processing path 42 passing through the shifter 12 and alignment and rounding circuitry 10. The bypass path 40 has alignment and rounding circuitry 50 in the second pipeline stage which is the same as the alignment and rounding circuitry 10 included by the second processing path 42 in the third pipeline stage. The third pipeline stage of the bypass path 40 functions as a no-operation pipeline stage which simply buffers the output of the preceding stage for a cycle without changing its value. A multiplexer 52 is provided to select between the outputs of the bypass path 40 and the second path 42.

The control circuitry 36 has associated denormal detection circuitry 38 for detecting whether the input operands A, B are such that a denormal value will be expected to be generated by the first pipeline stage. While FIG. 4 shows the denormal detection circuitry 38 as separate from the control circuitry 36, in other examples the denormal detection circuitry 38 may be part of the control circuitry 36. The denormal detection circuitry 38 detects that a denormal value will occur if the input operands A, B satisfy a predetermined condition. The predetermined condition may be that one or both of the input operands A, B is itself denormal (i.e. all the bits of the exponent E are 0 and the significand F is non-zero for one or both of the operands A, B), or that the input operands A, B are such that product produced by the multiplier 4 will be denormal. The denormal detection logic 38 can determine whether the product will be denormal in different ways. It is possible for the denormal detection logic 38 to use the actual product of the multiplier 4 and exponent produced by adder 6 and inspect these to see whether the result is denormal. However, this could be slow, and a quicker way of estimating whether the product will be denormal in the case where both input operands are normal is to add the exponents E of the input operands A, B together, and if the sum of the exponents is less than a predetermined denormal threshold then this can indicate that there is at least the possibility of some denormal values occurring. This estimation may use the output of adder 6 or could perform a separate addition of the exponents within the denormal detection logic 38. For example, for single precision floating point, the denormal threshold may be −125 so that if the sum of the exponents is −126 or less then there is a risk that the result could be denormal. The denormal detection does not need to be a precise determination of whether the result is denormal. To simplify the processing it can be sufficient to make a conservative estimate which will detect all denormal cases but may flag some cases as denormal even if they do not in the end produce a denormal value.

The control circuitry 36 can select which of the paths 40, 42 should provide the output operand depending on whether the denormal detection logic 38 detects that the input operands A, B satisfy the predetermined condition for denormal handling. If the inputs are such that there is at least a chance of a denormal value occurring, then the control circuitry 36 controls the pipeline to perform the multiply operation in the same way as shown in FIG. 3 using the shifter 12 and alignment and rounding circuit 10 of the second path 42. The control circuitry controls the multiplexer 52 to select the output of the second path 42 and then the output operand is written to the destination register by write port 60. On the other hand, if the inputs do not satisfy the predetermined condition, then the control circuitry controls the pipeline so that the output is generated using the bypass path 40 in which only alignment and rounding is performed at circuit 50 and the normalisation shift is omitted. This means that the output operand becomes available a cycle earlier than would be the case using the second path 42 (the result is generated at the end of the second pipeline stage rather than the third).

An early forwarding path 70 is provided for outputting the output operand generated using the bypass path 40. The early forwarding path 70 provides the output operand so that it can be used by another operation (e.g. the add part of a multiply-add operation) earlier than would be the case if the subsequent operation had to wait until the result is available in the destination register. Nevertheless, even when the bypass path 40 is used to skip the normalisation shift 12, the write to the destination register from write port 60 occurs in the same cycle as would be the case if the second path 42 had been used and the denormal processing was required. This makes management of the register write easier, since if it is determined that denormal processing is not required, it is not necessary to obtain a free slot on a write port of the register file 34 a cycle earlier than would have been reserved at the issue stage.

FIG. 4 shows an example in which both paths 40, 42 remain active for each operation regardless of whether denormal processing is required. The product produced by multiplier 4 is provided to both paths 40, 42 which each determine a result, and the multiplexer 52 is then controlled by control circuitry 36 to select the appropriate result depending on the result of the denormal detection logic 38, and the control circuitry 36 also controls whether the forwarding path 70 forwards the result of the bypass path 42 depending on whether the input operands satisfy the predetermined denormal condition. However, in other embodiments, the one of the paths 40, 42 which is not required could be made inactive with only the selected path 40, 42 generating the output operand. Hence, while in response the determination of the denormal detection logic, the control circuitry 36 should at least control the pipeline 30 to perform the multiply operation including or bypassing the conditional denormal handling step, it is optional whether or not the other path is also active at this point.

The control circuitry 36 may also receive a control input 80 which represents a “flush to zero” (FTZ) mode in which denormal handling is disabled. For example, when the FTZ control signal 80 is 1 then this may indicate that the flush to zero mode is active so that denormal handling is disabled, while when the FTZ control signal 80 is 0 then denormal handling may be enabled. When denormal handling is enabled, then the pipeline 30 operates as discussed above to detect whether the input operands satisfy the condition and control the output operand to be produced by one of the paths 40, 42 depending on the condition determination. On the other hand, when denormal handling is disabled, then any denormal values are treated as zero, the denormal detection is deactivated and the output of the bypass path 40 can be selected for all multiply operations. By selecting the FTZ mode if it is known that there will not be any denormal values, then this can reduce the power consumed by the denormal detection circuitry and the denormal handling path 42. Unlike previous circuits which implement an FTZ mode, however, which when denormal handling is enabled would pass all instructions through the normalization shift stage 12, in the present technique when denormal handling is enabled then it is determined dynamically based on the input operands whether the denormal handling is required so that the denormal processing step can be bypassed if possible.

As well as the early forwarding path 70, the pipeline may also have a second forwarding path 72 which forwards the output value, which is about to be written to the destination register, to other processing circuits for use by other instructions before it has actually been written to the destination register. This can allow the other instruction to start a processing cycle earlier.

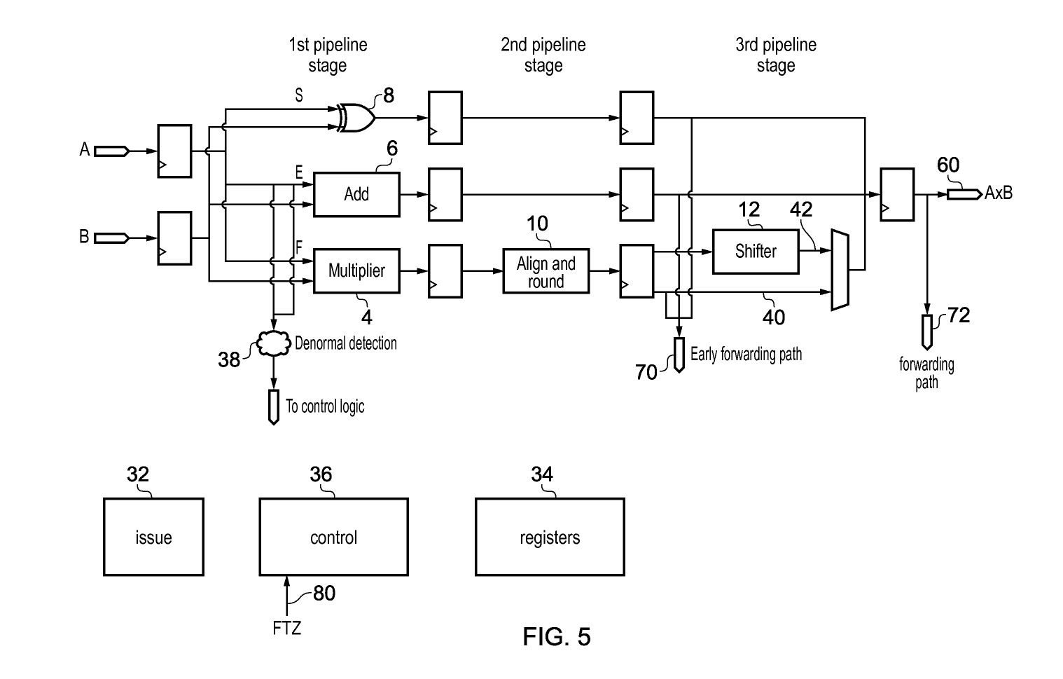

FIG. 4 shows an example in which the alignment and rounding step 10 is performed after the normalisation shift 12 in the second processing path 42. However, it is also possible to perform the alignment and rounding step 10 before the shift 12, as shown in the example of FIG. 5. In this case, the rounding circuitry 10 may be modified to support injection rounding in which a rounding value can be injected at a position other than the least significant bit of the product, so that when the value is subsequently shifted by the shifter 12 then this will cause the rounded bit to be moved to the least significant bit of the output operand. In the example of FIG. 5, since the conditional step performed by the shifter 12 is the last step performed by the pipeline, then it is not necessary to provide two versions of the align/round circuit 10, one in the bypass path 40 and one in the second path 42 as in FIG. 4, since now it can be shared between both paths 40, 42. Therefore, in the example of FIG. 5 the bypass path 40 may simply comprise a no-operation pipeline stage, and need not comprise any other kind of processing circuitry. The denormal detection circuitry 38 determines whether the inputs A, B satisfy the predetermined condition which indicates that there is a risk of denormal values occurring. If the input operands do not satisfy the condition then the shifter 12 is bypassed and the early forwarding path 70 forwards the output operand to subsequent instructions at least one cycle earlier than would be the case if the shifter 12 is required. Nevertheless, the register write from write port 60 occurs the same number of cycles after the first pipeline stage regardless of whether denormal handling is performed.

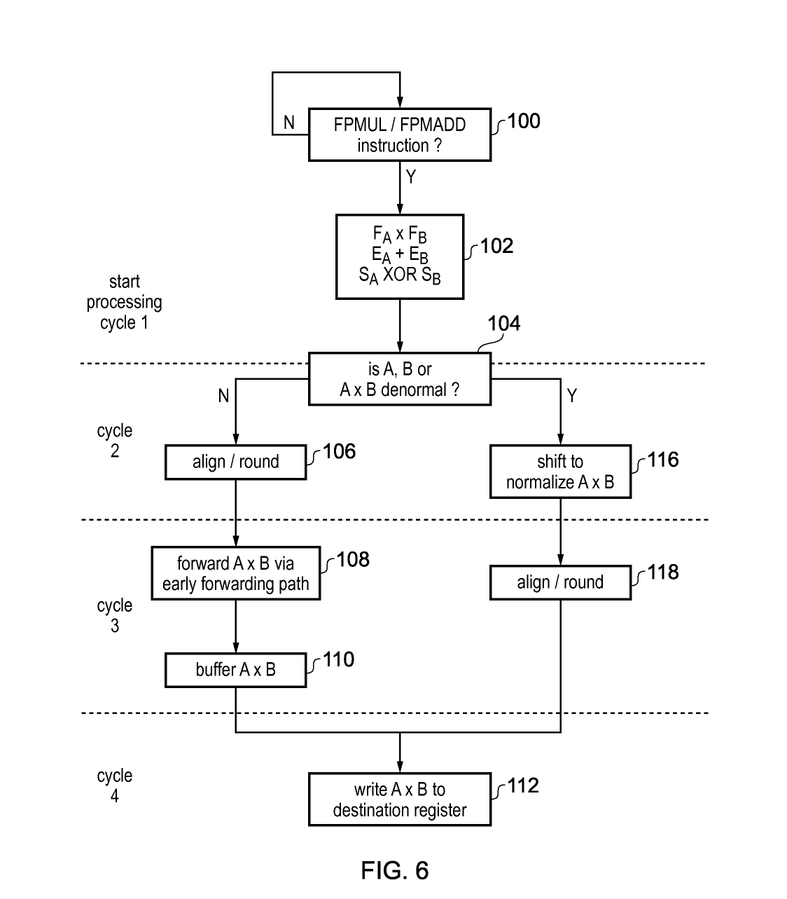

FIG. 6 is a flow diagram illustrating a method of data processing using the embodiment of FIG. 4 for example. At step 100 it is determined whether a floating point multiply or multiply-add instruction has been received by the processing pipeline 30. If so then at step 102 the significands, exponents and sign bits of the input operands A, B are provided to the multiplier 4, adder 6 and XOR gate 8 of the first pipeline stage respectively. The multiplier multiplies the significands F_{A}, F_{B}, the adder 6 adds the exponents E_{A}, E_{B} and the XOR gate 8 XORs the sign bits S_{A}, S_{B} to produce the corresponding significand, exponent and sign bit of the product of the two input operands. Step 102 takes place during a start processing cycle (cycle 1). Either in the start processing cycle or in the next processing cycle 2, at step 104 the denormal detection logic 38 determines whether either of the input operands A, B or the product A×B is denormal.

If neither the inputs A, B nor the product A×B is determined to be denormal, then at step 106 in processing cycle 2 the alignment and rounding circuitry 50 aligns and rounds the product produced by the multiplier 4 to generate the significand of the result value which is combined with the exponent produced by the adder 6 and the sign bit produced by XOR gate 8 to form the output operand, which is forwarded along the early forwarding path 70 at step 108 during processing cycle 3. The bypass path 40 buffers the output operand for a processing cycle at step 110. At step 112, during processing cycle 4, the output operand is written to the destination register.

On the other hand, if either of the inputs or the product is denormal at step 104, then at step 116, which occurs during processing cycle 2, the shifter 12 of the second processing path 42 shifts the result of the multiplier 4 to normalise or denormalise the floating point value. In processing cycle 3, the shifted value is aligned and rounded using circuitry 10 to produce the output operand (step 118). At step 112, in processing cycle 4, the output operand is written to the destination register. Hence, regardless of whether the denormal handling is required or not, the register write occurs in the same processing cycle 4. However, the forwarding step 108 in cycle 3 means that other instructions can access the operand produced in the case where denormal handling is not required earlier than would be the case if all instructions had to go down the denormal handling path. This results in a more efficient processor which has improved performance.

If at step 100 the instruction was determined to be a floating point multiply-add instruction, then the output operand produced by the multiply pipeline 30 would be sent to an add pipeline to perform a subsequent add operation. If the bypass path 40 is used then the early forwarding path 70 would be used to forward the output operand to the add pipeline, while if the second path 42 is used then the second forwarding path 72 can be used so that the add pipeline does not need to wait for the register write to complete.

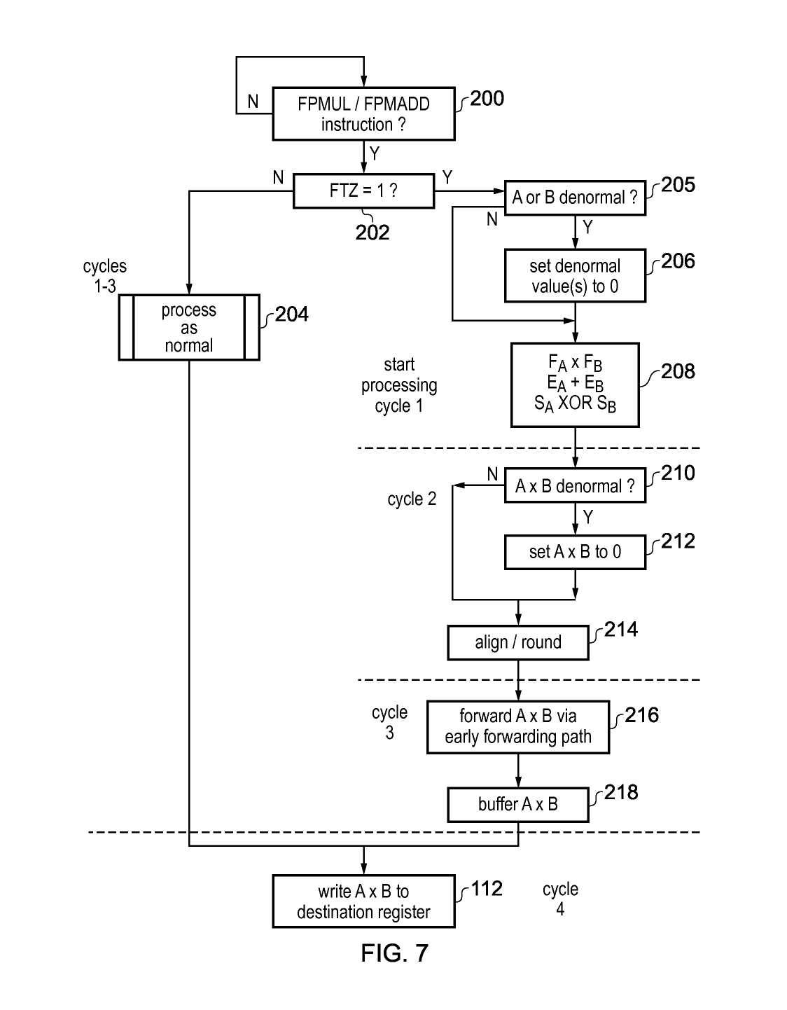

FIG. 7 shows another flow diagram which illustrates handling of the FTZ mode. Again, at step 100 it is determined whether there is a floating point multiply or multiply-add instruction. At step 202 it is determined whether the FTZ control signal 80 is 1 indicating that denormal handling is disabled. If not, then at step 204 the multiply operation is performed in the same way as in FIG. 6 (step 204 comprises steps 102, 104, 106, 108, 110, 116 and 118 of FIG. 6). The output operand is then written to the destination register in processing cycle 4 in the same way as in FIG. 6 (step 112).

If the control signal 80 is 1, then the flush to zero mode is active and denormal handling is disabled. At step 205, it is determined whether either of the input operands A, B is denormal. If so then at step 206 any denormal value is set to zero, while if there are no denormal inputs then step 206 is omitted. At step 208, the multiplier 4, adder 6 and XOR gate 8 generate the significand, exponent and sign bit of the product A×B in the same way as step 102 of FIG. 6. This occurs in the first processing cycle.

In the second processing cycle, it is determined whether the product A×B produced by multiplier 4 is denormal (step 210). If so then at step 212 the product is also forced to zero, while if the product is normal then step 212 is omitted. In the FTZ mode, denormal handling is never required and so the bypass path 40 is always selected. Therefore, at step 214 the alignment and rounding circuit 50 produces the output operand during the second processing cycle. In the third processing cycle (step 216), the output operand is forwarded over path 70 (same as step 108 of FIG. 6) and the output operand is buffered for a cycle in the no-operation stage of bypass path 40 (step 218, which is the same as step 110 of FIG. 6). The output operand is then written to the destination register at step 112 during the fourth processing cycle. As shown in FIG. 7, the register write occurs the same number of cycles after the start cycle regardless of whether the flush to zero mode is selected.

While FIGS. 1 to 7 have been discussed in the context of floating point arithmetic, and more particularly denormal handling, the present technique can also apply to other operations. In general, any processing operation which has a conditional step which is sometimes required and sometimes not required, depending on the input operands, can use the present technique. In the examples of FIGS. 4 and 5, the shifter 12 could be replaced with the circuitry for performing the conditional step (which could in some examples require more than one pipeline stage), and the other parts of the pipeline 30 can be replaced with circuitry for performing shared steps of the operation which are required regardless of whether the input operands meet the required condition.

Handling of zero, NaN and infinite operands or overflow conditions have been omitted from FIGS. 6 and 7 for conciseness. These can be handled using any known prior art technique.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

I claim:

1. A data processing apparatus comprising:
a plurality of registers configured to store operands for processing;
a processing pipeline configured to perform a data processing operation for generating an output operand in response to at least one input operand and for writing the output operand to a destination register of said plurality of registers, the data processing operation including at least one conditional processing step which is required only if the at least one input operand satisfies a predetermined condition;
a forwarding path configured to forward the output operand for use by a subsequent data processing operation; and
control circuitry configured to detect whether the at least one input operand for the data processing operation satisfies the predetermined condition, and:
(a) if the at least one input operand does not satisfy the predetermined condition, to control the processing pipeline to perform the data processing operation bypassing the at least one conditional processing step to generate the output operand a first number of processing cycles later than a start processing cycle in which the processing pipeline starts performing the data processing operation, and to forward the output operand via the forwarding path before the output operand has been written to the destination register; and
(b) if the at least one input operand satisfies the predetermined condition, to control the processing pipeline to perform the data processing operation including the at least one conditional processing step to generate the output operand a second number of processing cycles later than the start processing cycle, where the second number is greater than the first number;
wherein the processing pipeline is configured to write the output operand to the destination register a predetermined number of processing cycles later than the start processing cycle, said predetermined number being the same regardless of whether the at least one input operand satisfies the predetermined condition.

2. The data processing apparatus according to claim 1, wherein the processing pipeline comprises a bypass processing path and a second processing path, wherein the second processing path comprises circuitry for performing the at least one conditional processing step, and the bypass processing path does not comprise circuitry for performing the at least one conditional processing step.

3. The data processing apparatus according to claim 2, wherein the processing pipeline comprises a shared processing path configured to perform at least one initial processing step required by the data processing operation regardless of whether the at least one input operand satisfies the predetermined condition.

4. The data processing apparatus according to claim 2, wherein the bypass processing path comprises at least one no-operation pipeline stage configured to receive the output value from a preceding pipeline stage and configured to output the received output value unchanged.

5. The data processing apparatus according to claim 2, wherein the data processing operation comprises at least one further processing step required regardless of whether the at least one input operand satisfies the predetermined condition, wherein if the at least one input operand satisfies the predetermined condition then the at least one further processing step occurs after the at least one conditional processing step.

6. The data processing apparatus according to claim 5, wherein the second processing path comprises circuitry configured to start performing the at least one further processing step a third number of processing cycles later than the start processing cycle; and
the bypass processing path comprises circuitry configured to start performing the at least one further processing step a fourth number of processing cycles later than the start processing cycle, where the third number is greater than the fourth number.

7. The data processing apparatus according to claim 1, wherein the data processing operation comprises a floating point data processing operation and the at least one input operand and the output operand comprise floating point operands each having a significand and an exponent.

8. The data processing apparatus according to claim 7, wherein the at least one conditional step comprises one or more steps for handling a denormal floating point value.

9. The data processing apparatus according to claim 8, wherein the at least one conditional step comprises one or more steps for normalising the denormal floating point value to generate a normal floating point value.

10. The data processing apparatus according to claim 8, wherein the at least one conditional step comprises one or more steps for denormalising a normal floating point value to generate the denormal floating point value.

11. The data processing apparatus according to claim 8, wherein the control circuitry is configured to determine that the predetermined condition is satisfied if the at least one input operand is such that an operand processed by the processing pipeline has a denormal floating point value.

12. The data processing apparatus according to claim 7, wherein the data processing operation comprises a floating point multiply operation for multiplying two input operands to generate the output operand.

13. The data processing apparatus according to claim 12, wherein the control circuitry is configured to determine that the predetermined condition is satisfied if at least one of the two input operands has a denormal floating point value.

14. The data processing apparatus according to claim 12, wherein the control circuitry is configured to determine that the predetermined condition is satisfied if a product of the two input operands would have a denormal floating point value.

15. The data processing apparatus according to claim 12, wherein the control circuitry is configured to determine that the predetermined condition is satisfied if the sum of the exponents of the two input operands is less than a predetermined denormal threshold.

16. The data processing apparatus according to claim 8, wherein the control circuitry is configured to receive a control signal indicating whether handling of denormal floating point values is enabled or disabled.

17. The data processing apparatus according to claim 16, wherein:
if the control signal indicates that handing of denormal floating point values is disabled, then the control circuitry is configured to control the processing pipeline to replace denormal floating point values with zero, and to control the processing pipeline to perform the data processing operation bypassing the at least one conditional processing step; and
if the control signal indicates that handling of denormal floating point values is enabled, then the control circuitry is configured to control whether the data processing operation is performed bypassing or including the at least one conditional processing step in dependence on whether the at least one input operand satisfies the predetermined condition.

18. The data processing apparatus according to claim 16, wherein the processing pipeline is configured to write the output operand to the destination register the predetermined number of processing cycles later than the start processing cycle, the predetermined number being the same regardless of whether the control signal indicates that handling of denormal floating point values is enabled or disabled.

19. The data processing apparatus according to claim 12, comprising issue circuitry configured to issue a floating point multiply instruction to the processing pipeline to trigger the processing pipeline to perform the floating point multiply operation.

20. A data processing apparatus comprising:
a plurality of register means for storing operands for processing;
processing pipeline means for performing a data processing operation for generating an output operand in response to at least one input operand and for writing the output operand to a destination register means of said plurality of register means, the data processing operation including at least one conditional processing step which is required only if the at least one input operand satisfies a predetermined condition;
forwarding means for forwarding the output operand for use by a subsequent data processing operation; and
control means for detecting whether the at least one input operand for the data processing operation satisfies the predetermined condition, and:
(a) if the at least one input operand does not satisfy the predetermined condition, controlling the processing pipeline means to perform the data processing operation bypassing the at least one conditional processing step to generate the output operand a first number of processing cycles later than a start processing cycle in which the processing pipeline means starts performing the data processing operation, and to forward the output operand via the forwarding means before the output operand has been written to the destination register means; and
(b) if the at least one input operand satisfies the predetermined condition, controlling the processing pipeline means to perform the data processing operation including the at least one conditional processing step to generate the output operand a second number of processing cycles later than the start processing cycle, where the second number is greater than the first number;
wherein the processing pipeline means is configured to write the output operand to the destination register means a predetermined number of processing cycles later than the start processing cycle, said predetermined number being the same regardless of whether the at least one input operand satisfies the predetermined condition.

21. A method of performing a data processing operation for generating an output operand in response to at least one input operand and for writing the output operand to a destination register of a plurality of registers, the data processing operation including at least one conditional processing step which is required only if the at least one input operand satisfies a predetermined condition; the method comprising:
detecting whether the at least one input operand for the data processing operation satisfies the predetermined condition;
if the at least one input operand does not satisfy the predetermined condition, controlling a processing pipeline to perform the data processing operation bypassing the at least one conditional processing step to generate the output operand a first number of processing cycles later than a start processing cycle in which the processing pipeline starts performing the data processing operation, and forwarding the output operand via a forwarding path before the output operand has been written to the destination register, for use by a subsequent data processing operation;
if the at least one input operand satisfies the predetermined condition, controlling the processing pipeline to perform the data processing operation including the at least one conditional processing step to generate the output operand a second number of processing cycles later than the start processing cycle, where the second number is greater than the first number; and
writing the output operand to the destination register a predetermined number of processing cycles later than the start processing cycle, said predetermined number being the same regardless of whether the at least one input operand satisfies the predetermined condition.
